(19) United States
(12) Patent Application Publication
(10) Pub. No.: US 2022/0360898 A1
(43) Pub. Date: Nov. 10, 2022

(54) Modular Surround Sound Assembly

(71) Applicant: Jared Myers, Mentor, OH (US)

(72) Inventor: Jared Myers, Mentor, OH (US)

(21) Appl. No.: 17/308,697

(22) Filed: May 5, 2021

(51) Int. Cl. H04R 5/02; H04R 5/04; H04R 1/26; H04R 3/12

(52) U.S. Cl. CPC H04R 5/02; H04R 5/04; H04R 1/26; H04R 3/12; H04R 2205/021; H04R 2201/028; H04R 2205/024

(57) ABSTRACT

A modular surround sound assembly includes a base housing and an audio unit that is integrated into the base housing. The audio unit includes a plurality of base speakers integrated into the base housing. A communication port is integrated into the base housing and the communication port is in electrical communication with the audio unit. A docking station includes a docking cable that is matable to the communication port on the base housing. A plurality of satellite speakers is each pluggable into respective ones of a plurality of output ports on the docking station to emit audible sound corresponding to the audible sound emitted by the speakers in the base unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to surround sound devices and more particularly pertains to a new surround sound device for facilitating a surround home theater system or portable audio. The device includes a base unit with speakers and an audio unit and a docking station that can be plugged into the base unit. The docking station charges the base unit and a plurality of satellite speakers can be plugged into the docking station such that the satellite speakers work in tandem with the speakers in the base unit.

### (2) Description of Related Art Including Information Disclosed Under 37 CFR 1.97 and 1.98

The prior art relates to surround sound devices including a variety of surround sound systems that include a central unit and a plurality of satellite units. The prior art also discloses a method for automatically configuring a multiple speaker audio system. In no instance does the prior art disclose a modular surround sound system that includes a portable base unit which can function as a center channel of a surround sound system or as a standalone audio unit.

### BRIEF SUMMARY OF THE INVENTION

An embodiment of the disclosure meets the needs presented above by generally comprising a base housing and an audio unit that is integrated into the base housing. The audio unit includes a plurality of base speakers integrated into the base housing. A communication port is integrated into the base housing and the communication port is in electrical communication with the audio unit. A docking station includes a docking cable that is matable to the communication port on the base housing. A plurality of satellite speakers is each pluggable into respective ones of a plurality of output ports on the docking station to emit audible sound corresponding to the audible sound emitted by the speakers in the base unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a modular surround sound assembly according to an embodiment of the disclosure.

FIG. 2 is a front view of a base unit of an embodiment of the disclosure.

FIG. 3 is a back phantom view of an embodiment of the disclosure.

FIG. 4 is a top phantom view of an embodiment of the disclosure.

FIG. 5 is a schematic view of an embodiment of the disclosure.

### DETAILED DESCRIPTION OF THE INVENTION

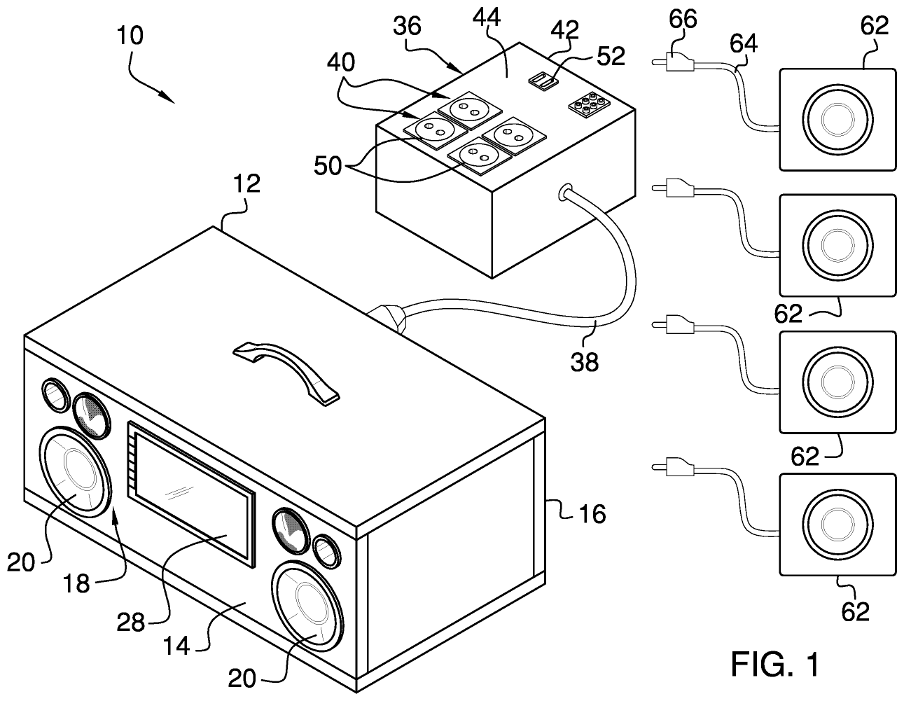

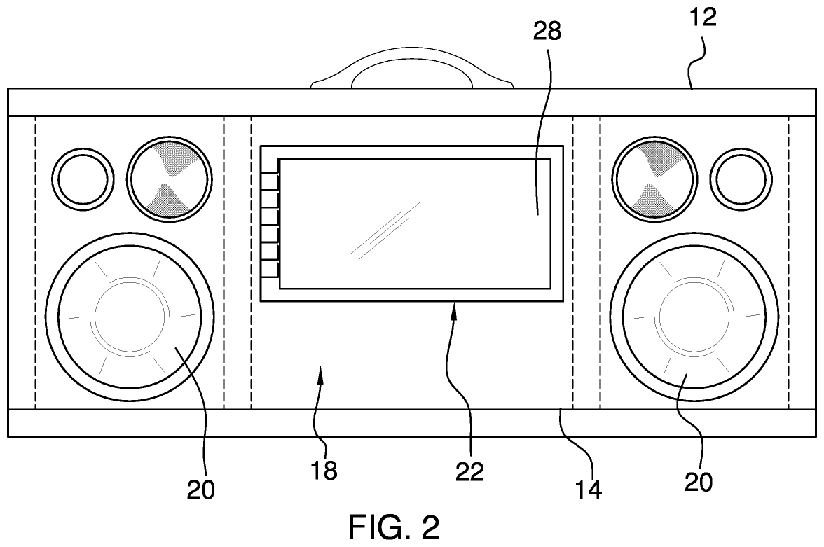

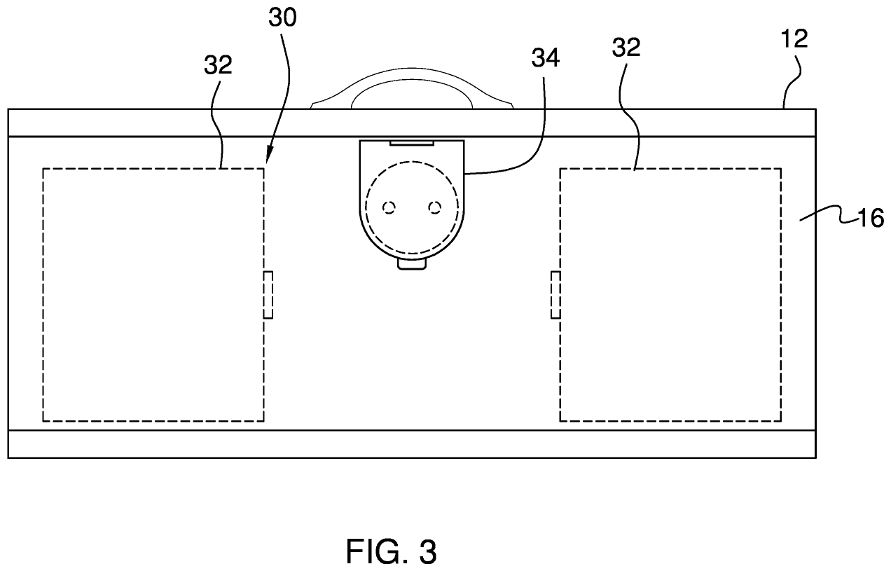

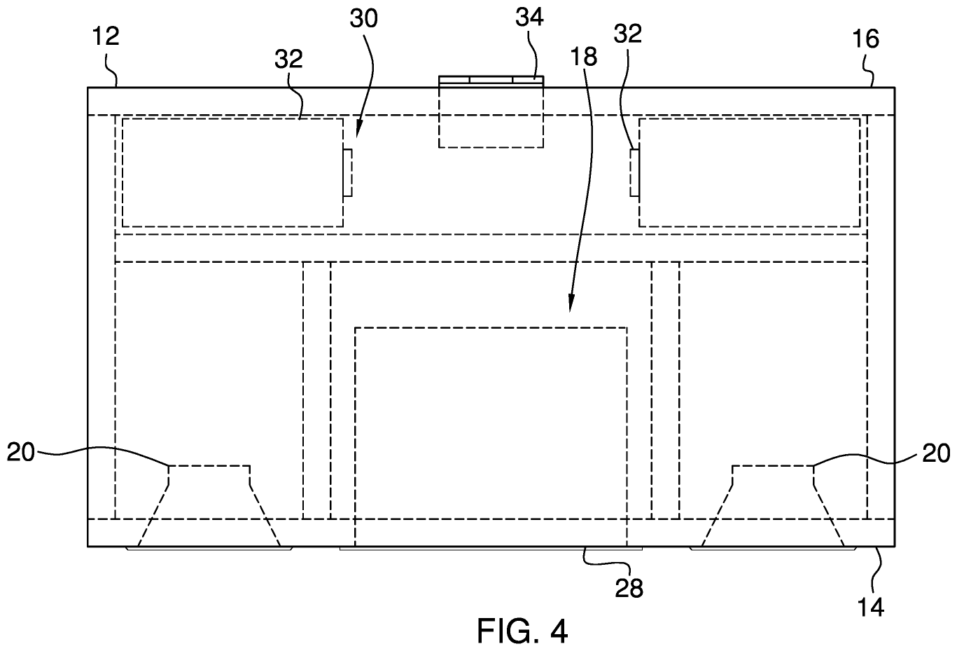

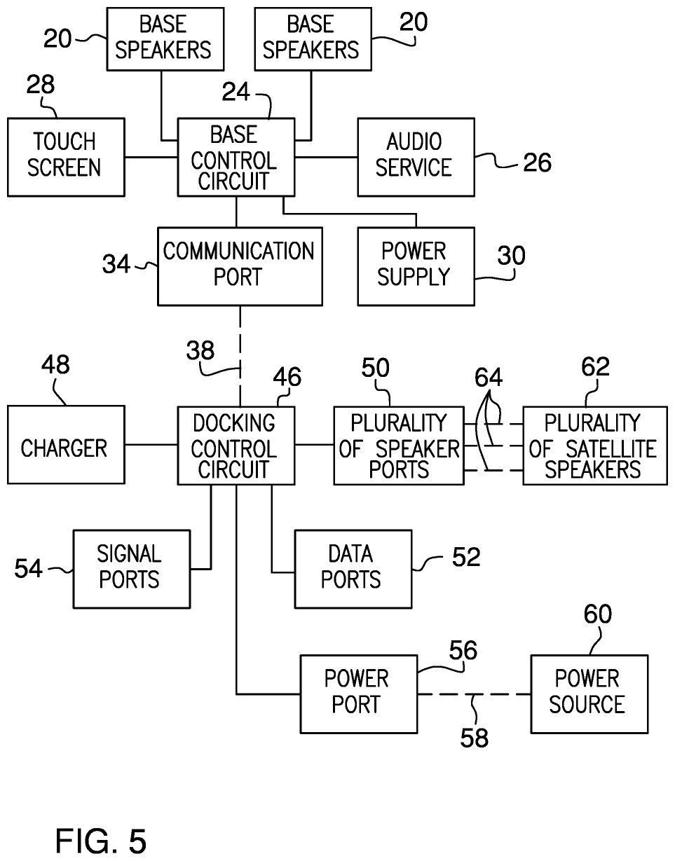

With reference now to the drawings, and in particular to FIGS. 1 through 5 thereof, a new surround sound device embodying the principles and concepts of an embodiment of the disclosure and generally designated by the reference numeral 10 will be described.

As best illustrated in FIGS. 1 through 5, the modular surround sound assembly 10 generally comprises a base housing 12 that has a forward side 14 and a rear side 16. An audio unit 18 is integrated into the base housing 12 and the audio unit 18 includes a plurality of base speakers 20 that are each integrated into the base housing 12. Each of the base speakers 20 emits audible sound outwardly from the base housing 12 and each of the base speakers 20 may comprise an electronic speaker of any conventional design. The audio unit 18 includes a graphic user interface 22 to facilitate a user to control operational parameters of the audio unit 18.

The audio unit 18 comprises a base control circuit 24 that is positioned in the base housing 12, and the base control circuit 24 includes signal amplification. Moreover, the base control circuit 24 may include circuitry common to home theater components, such as surround sound processing, balance, fader, volume, sound equalization and any other common audio processing functions. An audio source 26 is positioned in the base housing 12 and the audio source 26 is electrically coupled to the base control circuit 24. The audio source 26 transmits an audio signal to the base control circuit 24 for amplification. The audio source 26 may include a radio frequency receiver that employs Bluetooth communication protocols thereby facilitating the audio source 26 to by synched with a smart device. The audio source 26 may include an AM/FM receiver for receiving broadcast radio signals and any other type of audio source commonly employed with home audio systems.

The audio unit 18 includes a touch screen 28 that is coupled to the base housing 12 to define the graphic user interface 22 such that the touch screen 28 can be manipulated by a user. The touch screen 28 is electrically coupled to the base control circuit 24 and the touch screen 28 displays indicia comprising icons, words and symbols for controlling operational parameters of the base control circuit 24. The touch screen 28 is positioned on the forward side 14 of the base housing 12 and the touch screen 28 may comprise a liquid crystal display or other type of electronic touch screen 28. Each of the base speakers 20 is positioned on the forward side 14 of the base housing 12. Additionally, each of the base speakers 20 is electrically coupled to the base control circuit 24 thereby facilitating each of the base speakers 20 to receive the audio signal from the audio source 26.

The audio unit 18 includes a power supply 30 that is positioned in the base housing 12. The power supply 30 is electrically coupled to the audio unit 18 and the power supply 30 comprises at least one rechargeable battery 32. The at least one rechargeable battery 32 is electrically coupled to the base control circuit 24. A communication port 34 is integrated into the base housing 12 and the communication port 34 is in electrical communication with the audio unit 18. Additionally, the communication port 34 is electrically coupled to the base control circuit 24 and the communication port 34 is electrically coupled to the power supply 30. The communication port 34 may comprise a trailer plug that is common on vehicles for connecting trailer lights to the electrical system of the vehicle.

A docking station 36 is provided and the docking station 36 includes a docking cable 38 which extends away from the docking station 36. The docking cable 38 is matable to the communication port 34 on the base housing 12 such that the docking station 36 is in electrical communication with the audio unit 18 for charging the audio unit 18. Moreover, the docking station 36 receives an audio signal from the audio unit 18 when the docking cable 38 is mated to the communication port 34. The docking station 36 has a plurality of outputs 40 each receiving the audio signal from the audio unit 18 when the docking cable 38 is mated to the communication port 34. Additionally, the docking station 36 might include circuitry that is common to signal amplifiers for amplifying the audio signal that is sent to the outputs 40.

The docking station 36 comprises a docking housing 42 that has a top wall 44 and a docking control circuit 46 that is positioned in the docking housing 42. The docking control circuit 46 is electrically coupled to the docking cable 38 and the docking control circuit 46 is in communication with the base control circuit 24 when the docking cable 38 is mated to the communication port 34. The docking station 36 includes a charger 48 that is positioned in the docking housing 42. The charger 48 is electrically coupled to the docking control circuit 46 and the charger 48 is in communication with the power supply 30 in the audio unit 18 when the docking cable 38 is mated to the communication port 34 for charging the power supply 30. The charger 48 may comprise an electronic battery charger that has sufficient output to fully charge the at least one rechargeable battery 32 in the audio unit 18.

The docking station 36 includes a plurality of speaker ports 50 that is each integrated into the top wall 44 of the docking housing 42 to define respective ones of the outputs 40. Each of the speaker ports 50 is electrically coupled to the docking control circuit 46. A plurality of data ports 52 is each integrated into the top wall 44 of the docking housing 42 to define respective ones of the outputs 40. Each of the data ports 52 is electrically coupled to the docking control circuit 46. Each of the data ports 52 may comprise a high definition multimedia interface (HDMI) port 34, a universal serial bus (USB) port 34 or other type of video and audio interface. A plurality of signal ports 54 is each integrated into the top wall 44 of the docking housing 42 to define respective ones of the outputs 40, and each of the signal ports 54 is electrically coupled to the docking control circuit 46. Each of the signal ports 54 may comprise an RCA port or other type of audio port.

The docking station 36 includes a power port 56 that is integrated into the docking housing 42 to engage a power cord 58 that is electrically coupled to a power source 60. The power source 60 may comprise a female electrical outlet or the like. The power port 56 is electrically coupled to the docking control circuit 46 for supplying electrical power to the charger 48. The power port 56 may comprise a male electrical plug or other type of power plug that can engage the power cord 58.

A plurality of satellite speakers 62 is provided and each of the satellite speakers 62 is pluggable into respective ones of the outputs 40 on the docking station 36. Each of the satellite speakers 62 receives the audio signal from the audio unit 18 when the satellite speakers 62 are plugged into the outputs 40 and the docking cable 38 is mated to the communication port 34. In this way each of the satellite speakers 62 can emit audible sound corresponding to the audible sound that is emitted by the speakers in the base unit. Each of the satellite speakers 62 has an input cable 64 and the input cable 64 on each of the satellite speakers 62 has a plug 66 that is matable to respective ones of the speaker ports 50 in the docking housing 42. Each of the satellite speakers 62 may comprise an electronic speaker of any conventional design that is contained in a housing.

In use, the docking cable 38 is mated into the communication port 34 and each of the satellite speakers 62 is plugged into the respective speaker ports 50 in the docking station 36. In this way the base speakers 20 in the base housing 12 function as a center channel of a surround sound system and each of the satellite speakers 62 can function as satellite speakers of the surround sound system. Additionally, the power supply 30 in the base housing 12 is charged while the docking cable 38 is mated to the communication port 34. The docking cable 38 can be unmated from the communication port 34 thereby facilitating the base housing 12 to be portable. In this way the base housing 12 and the audio unit 18 can operate as a stand-alone unit to facilitate music to be played in a remote location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A modular surround sound assembly for facilitating home theater audio and portable audio, said assembly comprising:
a base housing, said base housing having a top side;
a handle fixedly coupled to and extending up from said top side of said base housing wherein said base housing is configured for being portable;
an audio unit being integrated into said base housing, said audio unit including a plurality of base speakers being integrated into said base housing wherein each of said base speakers is configured to emit audible sound outwardly from said base housing, said audio unit including a graphic user interface wherein said graphic user interface is configured to facilitate a user to control operational parameters of said audio unit;
a communication port being integrated into said base housing, said communication port being in electrical communication with said audio unit;
a docking station having a docking cable extending away from said docking station, said docking cable being matable to said communication port on said base housing such that said docking station is in electrical communication with said audio unit for charging said audio unit, said docking station receiving an audio signal from said audio unit when said docking cable is mated to said communication port, said docking station having a plurality of outputs each receiving said audio signal from said audio unit when said docking cable is mated to said communication port; and
a plurality of satellite speakers, each of said satellite speakers being pluggable into respective ones of said output ports on said docking station, each of said satellite speakers receiving said audio signal from said audio unit when said satellite speakers are plugged into said output ports and said docking cable is mated to said communication port wherein each of said satellite speakers is configured to emit audible sound corresponding to the audible sound emitted by said speakers in said base unit.

2. The assembly according to claim 1, wherein said audio unit comprises:
a base control circuit being positioned in said base housing, said base control circuit including signal amplification;
an audio source being positioned in said base housing, said audio source being electrically coupled to said base control circuit, said audio source transmitting an audio signal to said base control circuit for amplification;
a touch screen being coupled to said base housing to define said graphic user interface wherein said touch screen is configured to be manipulated by a user, said touch screen being electrically coupled to said base control circuit, said touch screen displaying indicia comprising icons, words and symbols for controlling operational parameters of said base control circuit, said touch screen being positioned on said forward side of said base housing;
wherein each of said base speakers is positioned on said forward side of said base housing, each of said base speakers being electrically coupled to said base control circuit thereby facilitating each of said base speakers to receive said audio signal from said audio source; and
a power supply being positioned in said base housing, said power supply being electrically coupled to said audio unit, said power supply comprising at least one rechargeable battery, said at least one rechargeable battery being electrically coupled to said base control circuit.

3. The assembly according to claim 2, wherein said communication port being electrically coupled to said base control circuit, said communication portion being electrically coupled to said power supply.

4. The assembly according to claim 1, wherein:
audio unit comprises:
a base control circuit being positioned in said base housing, said base control circuit including signal amplification;
an audio source being positioned in said base housing, said audio source being electrically coupled to said base control circuit, said audio source transmitting an audio signal to said base control circuit for amplification; and
a power supply being positioned in said base housing, said power supply being electrically coupled to said audio unit, said power supply comprising at least one rechargeable battery, said at least one rechargeable battery being electrically coupled to said base control circuit;
said communication port is electrically coupled to said base control circuit, said communication portion being electrically coupled to said power supply; and
said docking station comprises:
a docking housing having a top wall;
a docking control circuit being positioned in said docking housing, said docking control circuit being electrically coupled to said docking cable, said docking control circuit being in communication with said base control circuit when said docking cable is mated to said communication port;
a charger being positioned in said docking housing, said charger being electrically coupled to said docking control circuit, said charger being in communication with said power supply in said audio unit when said docking cable is mated to said communication port for charging said power supply; and
a power port being integrated into said docking housing wherein said power port is configured to engage a power cord electrically coupled to a power source, said power port being electrically coupled to said docking control circuit for supplying electrical power to said charger.

5. The assembly according to claim 4, wherein said docking station includes:
a plurality of speaker ports, each of said speaker ports being integrated into said top wall of said docking housing to define respective ones of said outputs, each of said speaker ports being electrically coupled to said docking control circuit;
a plurality of data ports, each of said data ports being integrated into said top wall of said docking housing to define respective ones of said outputs, each of said data ports being electrically coupled to said docking control circuit; and
a plurality of signal ports, each of said signal ports being integrated into said top wall of said docking housing to define respective ones of said outputs, each of said signal ports being electrically coupled to said docking control circuit.

6. A modular surround sound assembly for facilitating home theater audio and portable audio, said assembly comprising:
a base housing having a forward side, a top side, and a rear side;
a handle fixedly coupled to and extending up from said top side of said base housing wherein said base housing is configured for being portable;
an audio unit being integrated into said base housing, said audio unit including a plurality of base speakers being integrated into said base housing wherein each of said base speakers is configured to emit audible sound outwardly from said base housing, said audio unit including a graphic user interface wherein said graphic user interface is configured to facilitate a user to control operational parameters of said audio unit, said audio unit comprising:
a base control circuit being positioned in said base housing, said base control circuit including signal amplification;
an audio source being positioned in said base housing, said audio source being electrically coupled to said base control circuit, said audio source transmitting an audio signal to said base control circuit for amplification;
a touch screen being coupled to said base housing to define said graphic user interface wherein said touch screen is configured to be manipulated by a user, said touch screen being electrically coupled to said base control circuit, said touch screen displaying indicia comprising icons, words and symbols for controlling operational parameters of said base control circuit, said touch screen being positioned on said forward side of said base housing;
each of said base speakers being positioned on said forward side of said base housing, each of said base speakers being electrically coupled to said base control circuit thereby facilitating each of said base speakers to receive said audio signal from said audio source; and
a power supply being positioned in said base housing, said power supply being electrically coupled to said audio unit, said power supply comprising at least one rechargeable battery, said at least one rechargeable battery being electrically coupled to said base control circuit;
a communication port being integrated into said base housing, said communication port being in electrical communication with said audio unit, said communication port being electrically coupled to said base control circuit, said communication portion being electrically coupled to said power supply;
a docking station having a docking cable extending away from said docking station, said docking cable being matable to said communication port on said base housing such that said docking station is in electrical communication with said audio unit for charging said audio unit, said docking station receiving an audio signal from said audio unit when said docking cable is mated to said communication port, said docking station having a plurality of outputs each receiving said audio signal from said audio unit when said docking cable is mated to said communication port, said docking station comprising:
a docking housing having a top wall;
a docking control circuit being positioned in said docking housing, said docking control circuit being electrically coupled to said docking cable, said docking control circuit being in communication with said base control circuit when said docking cable is mated to said communication port;
a charger being positioned in said docking housing, said charger being electrically coupled to said docking control circuit, said charger being in communication with said power supply in said audio unit when said docking cable is mated to said communication port for charging said power supply;
a plurality of speaker ports, each of said speaker ports being integrated into said top wall of said docking housing to define respective ones of said outputs, each of said speaker ports being electrically coupled to said docking control circuit;
a plurality of data ports, each of said data ports being integrated into said top wall of said docking housing to define respective ones of said outputs, each of said data ports being electrically coupled to said docking control circuit;
a plurality of signal ports, each of said signal ports being integrated into said top wall of said docking housing to define respective ones of said outputs, each of said signal ports being electrically coupled to said docking control circuit; and
a power port being integrated into said docking housing wherein said power port is configured to engage a power cord electrically coupled to a power source, said power port being electrically coupled to said docking control circuit for supplying electrical power to said charger; and
a plurality of satellite speakers, each of said satellite speakers being pluggable into respective ones of said output ports on said docking station, each of said satellite speakers receiving said audio signal from said audio unit when said satellite speakers are plugged into said output ports and said docking cable is mated to said communication port wherein each of said satellite speakers is configured to emit audible sound corresponding to the audible sound emitted by said speakers in said base unit, each of said satellite speakers having an input cable, said input cable on each of said satellite speakers having a plug being matable to a respective ones of said speaker ports in said docking housing.
